(19) United States
(12) Patent Application Publication
(10) Pub. No.: US 2012/0086210 A1
(43) Pub. Date: Apr. 12, 2012

(54) Device for Extracting Energy from Moving Air or Moving Water

(76) Inventor: Dennis John Gray, Spring, TX (US)

(21) Appl. No.: 12/900,036

(22) Filed: Oct. 7, 2010

(51) Int. Cl. F03D 5/00

(52) U.S. Cl. 290/55

(57) ABSTRACT

This invention is a device for transforming the energy of moving air or moving water into useable energy. The device comprises one or more rope or rope storage drums, one or more ropes, one or more generators, and a means by which to receive the force generated by moving air or moving water such as a wing or sail. A gearbox or transmission may be added between drum and generator to increase the rotational speed of the generator. The device may be controlled via autopilot systems whereby the rope payout rates are optimized for maximum energy production.

CROSS-REFERENCES TO MOST RELATED APPLICATIONS

| Patent or | |
|---|---|
| Application # | Title |
| 7,582,981 | Airborne wind turbine electricity generating system |
| 7,456,510 | Wind power generator |
| 7,354,245 | Wind power generation device |
| 7,317,261 | Power generating apparatus |
| 7,132,760 | Wind Turbine Device |
| 7,044,713 | Wind power generator with multiple rotary wings |
| 6,072,245 | Wind-driven driving apparatus employing kites |
| 6,666,650 | Wind power facility with a vertical rotor |
| 5,997,252 | Wind driven electrical power generating apparatus |
| 4,616,974 | Wind driven power generating apparatus |
| 4,613,763 | Wind driven electric power generating system |
| 4,572,962 | Apparatus for extracting energy from winds at high |
| | altitudes |
| 3,924,827 | Apparatus for extracting energy from winds at significant |
| | height |
| 6,327,994 | Scavenger energy converter system its new applications |
| 7,147,428 | Hydro Turbine |

### STATEMENT REGARDING FEDERALLY SPONSERED RESEARCH & DEVELOPMENT

Not Applicable. No others have rights to this patent. Dennis Gray is the sole inventor and the invention was not created under any federally sponsored programs.

### BACKGROUND OF THE INVENTION

Populations grow exponentially, world economies are expanding, demand for energy is escalating, global warming becomes more evident, and fossil fuels will eventually run out. Political tensions regarding hydrocarbons are high to say the least. The world needs solutions to these energy problems and they need them to be clean and cost-effective solutions.

Depending upon where they are installed, approximately 40-50% of the cost of a wind turbine is in the turbine blades, tower structures, tower foundations, and yaw drives that align turbines toward the winds. Instead of finding better ways to build these items this invention offers a way to eliminate them altogether and the solution allows wind energy to be extracted from very high elevations. Thus, amongst the other benefits it allows most of a wind farm's real estate costs to be eliminated.

Traditional wind energy costs less than solar, biofuels, and other renewable energy resources. Wind energy can even costs less than natural gas and oil energies. However, wind energy still costs slightly more than coal and nuclear energy. A goal is to have wind energy cost less than coal and nuclear energy on a cost/kWh. Two things should occur for this to happen. First, wind turbines, or wind energy devices in general, need to be placed in consistent winds that blow at much higher speeds. Second, most of the cost of wind turbines needs to be eliminated. This invention offers a way to replace turbine blades with inexpensive parafoil kites and eliminate, tower structures, tower foundations, yaw drives, and much of a wind turbine's real estate costs. The invention also places wind energy devices in consistent and higher speed winds at high elevations.

Higher elevations clearly offer more consistent winds at much higher speeds. Many government aviation weather websites confirm this fact. A device's ability to extract wind energy grows to the cubed power with wind speeds. All wind turbine power output charts confirm this. For every doubling of wind speeds we can potentially extract up to 8 times as much power. Increasing wind speed from 10 mph to 20 mph to 40 mph and finally to 80 mph can potentially result in 8×8×8 or 512 times as much power. Said another way, we can potentially generate 512 times as much power from the same wind turbine or wind energy system in 80 mph winds as we can in 10 mph winds. Even after considering the lower air density at high elevations we can extract more than 200 times as much power.

Clearly, it is not cost-effective nor practical to build a tower structure up to high elevations. The invention herein has a fraction of the costs, consists of fairly standard items, and achieves power via lift force generated from a lightweight sail, kite, or wing instead of heavy and expensive turbine blades. The sail, kite or wing can generally be considered a means by which to extract the force of moving air. Similarly, an equivalent system designed for use in water can extract energy from flowing waters, currents, and rivers.

There are many reasons why turbine blades and machinery should not be lifted into the sky. After extensive research and analysis it was deemed impractical to use a wing to lift a wind turbine (where turbine blades act as wings themselves) to eventually rotate a generator. In short, it is not practical nor cost-effective to use wings to lift wings when the first wings theseselves can be used to generate electricity.

With typical high elevation wind turbines there is an enormous amount of weight associated with gearbox, generator, electric cable running up to the sky, and other necessary items. Some designs attempt to use helium or hot air balloons to lift such items. This approach has overwhelming drawbacks. To lift even small weights very large balloon volumes are necessary. Consider and scale that a child's balloon can only lift a paperclip. To lift a wind turbine's machinery, even machinery made of aluminium, the balloon must be approximately the size of a basketball stadium. Huge balloons of this size result in enormous drag forces when placed in high speed winds. These drag forces, in turn, cause the balloons to blow far back in the wind, straight back in the wind, which results in enormously long cable lengths (potentially 10+ miles in length). In reality, these large balloons blow back in the wind until the cable pivots far enough for the balloons to drop down into lower wind speeds (which defeats the purpose).

If one were to hold the string of a child's balloon out of a car window when the car was travelling at 30+ mph they would see the balloon blow straight back. A similar but larger event happens when enormous balloons are placed in 30+ mph winds at high elevations, especially when the lift of the larger balloon is consumed in lifting machinery. The end result is very long cable lengths and when cables are miles long, as is the case with most high elevations wind energy systems, the cable can exceed the cost of all other items (wings, wind turbines, etc).

Last but not least, for safety reasons alone it is best to not elevate turbine blades, gearboxes, generators, or any heavy wind turbine equipment if it is not necessary. If/when equipment were to fall it could the results could be catastrophic. Over a long enough period of time a disaster becomes inevitable when heavy machinery is lifted into the sky.

### BRIEF SUMMARY OF THE INVENTION

A device for transforming the energy of moving air or moving water into useable energy comprising one or more rope or rope storage drums, one or more ropes, one or more generators, and a wing, sail, or other means by which to receive the force generated by moving air or moving water. Autopilot controls can be added to ensure that the invention continues to operate without human involvement.

### BRIEF DESCRIPTION OF THE SEVERAL VIEWS OF THE DRAWINGS

FIG. 1 is an isometric view of an embodiment of the invention for use in winds.

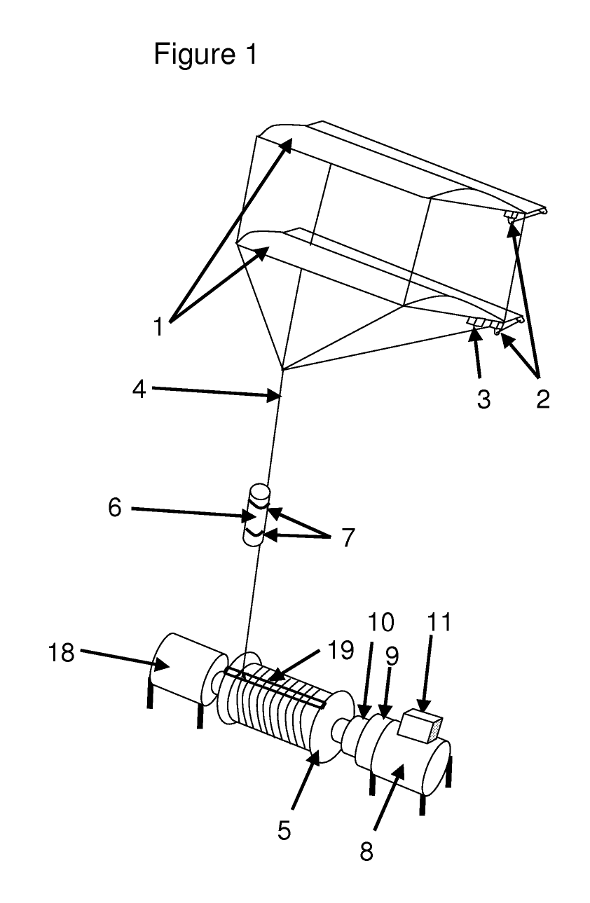

FIG. 2 is an isometric view of an embodiment for use in water currents, tides, rivers, etc.

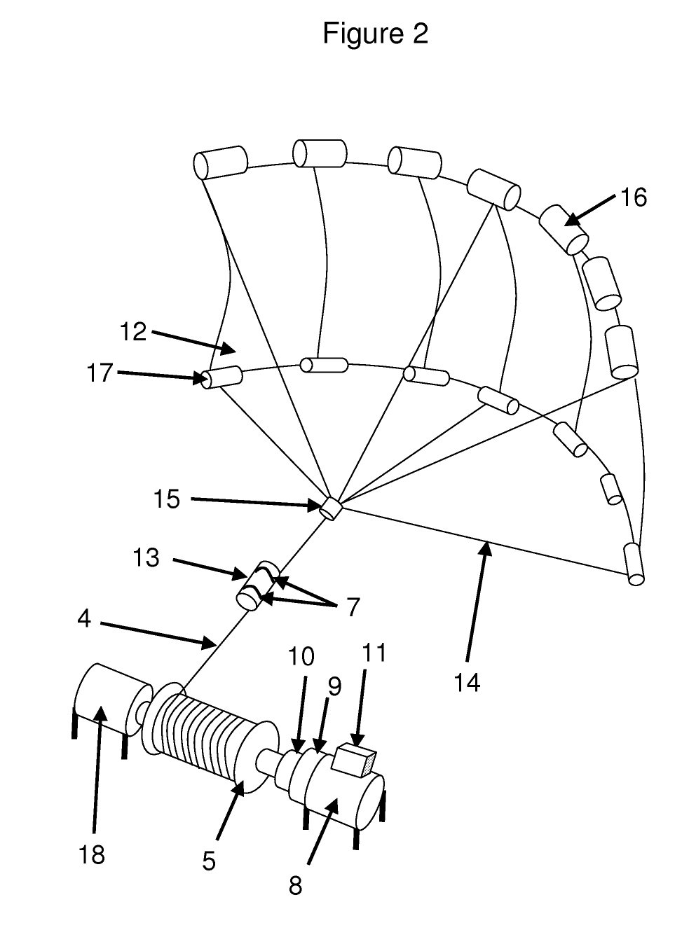

### DESCRIPTION OF A PREFERRED EMBODIMENT

A preferred embodiment of this invention uses lightweight wings (1) which can be made of kite fabric or other suitable materials. Extremely lightweight parafoil wings are a good choice but for added control and stability capability a full sailplane could be used. In essence, a means by which to receive the force of wind is flown and no turbine blades or other wind turbine machinery needs to be lifted into the sky. This results in lowest capital costs, lowest cost/kWh from the renewable energy system, and it also offers the safest solution.

The wing, or wings if several of them are used on a single line, should have a means by which to control their pitch, angle of attack, or otherwise control their elevation in the sky. A servo with control arm that tilts elevators/flaps is just one example of how the wing's lift could be controlled. This means by which to control the wing (2) would ideally be operated via radio control and fully automated. It could be powered by a battery (3), solar panels, small wind turbine, or any other means by which to provide power. The wing would rise, fall, and otherwise be controlled via autopilot. The wing would preferably fly at high elevation where winds are faster. This also decreases visual impacts. In fact, if flown high enough and the wing were made transparent or sky colored it could disappear from sight altogether. To get the wing off the ground in low wind speeds, one might inflate the wings with helium, include a helium balloon, include a series of helium balloons, etc. In most cases a small amount of wind would be available and the wing could take flight on its own.

A rope (4) would run from a rope storage drum (5) at ground level to the wing or wings at high elevation. The rope may be connected under the wing's center of lift. Helium balloons (6) may be intermittently installed at various points along the rope to help ensure that the rope essentially remains weightless once high altitudes are achieved and rope payout lengths increase significantly. Helium balloons, or another means to essentially keep the rope lightweight if not weightless, would help ensure maximum pulling force for the wing when the wing ascends during operation. In essence, the only tension in the rope would be due to the lift force of the wing (1) if helium balloons were attached to make the rope weightless. Straps (7), belts, or other devices could be used to temporarily secure rope balloons to the rope. Since it would be difficult to reel the balloons onto the rope storage drum, the balloons would likely be installed as the rope was paid out and removed before the rope was reeled in. The length of rope near the drum, or the segment of rope that was reeled on and off the drum during continuous device operation, would likely be kept free of balloons altogether. This would enable the free reeling of rope during ascent and descent of the wings and operation of the device.

At a pre-determined elevation, say 12,000 ft for example, the angle of attack on the wing could be adjusted to achieve maximum lift. This adjustment could occur via the control mechanism (2). As the wing achieves greatest lift and it ascends the rope (4) would pay out with great force and in turn rotate the rope storage drum (5) which would in turn rotate an electric generator (8). A gearbox (9) could be added between the drum (5) and generator (8) to enable the generator to spin even faster. Sometime later, when the wing (1) has climbed to an altitude of say 20,000 ft, the wing's lift could again be adjusted by the mechanism (2) to achieve minimal or negative lift. The wing would descend and a very small amount of energy could be used by the generator/motor (8) to reel in slack rope. Alternatively, a spring could reel in the slack rope much like a common tape measure automatically retracts measuring tape once the tape has been spooled out. The wing could descend very quickly so that the duration of time during energy production (wing ascending) could be much greater than the duration of time during reeling of slack rope (wing descending). Said another way, for every 10 minutes of rope pulling and energy generation there could be just 30 seconds of reeling in rope for the next cycle. A one-way clutch (10) could be added to disengage the gearbox and generator during wing descent which would greatly decrease the energy required to reel in slack rope. Orders of magnitude more energy is generated by the wing pulling out the rope than is consumed by reeling in slack rope during the return cycle. The net difference is the available energy from the device. The sequence of rope deployment and recovery can be repeated again and again for almost endless energy production. If the rope were retracted via spring mechanism, the energy stored by the spring could be used to drive the generator during the wing's descent. In this way, energy would be produced during both ascent and descent. If many devices were used there could be a fairly constant stream of outgoing power since their operation sequences can be staggered. Many wings, sailplanes, or other means to receive the force of wind could be attached to a single rope for greater line pull and increased energy production. Obviously, coordination of these multiple wings would be necessary.

Many wings on a single rope would decrease the amount of land occupied in comparison with typical wind turbine farms. This, in turn, would decrease real estate costs and aesthetic issues associated with traditional wind turbine arrays. With more sophisticated wing controls it is also conceivable to have multiple lines running from the same long drum with all of them delivering their torque to a single generator mounted at the end of the long drum. Computer, software, transmitter, and other associated equipment (11), or another means by which to automatically control one or more components automatically or at least semi-automatically, could allow for movements, controls, and energy production to occur without human involvement. This, in turn, would greatly reduce the cost/kWh from the device or groups of devices.

With few changes this system could be used to harness the energy of moving water as well. The system could be installed in rivers, tides, and ocean currents. Some differences include the wing being more of an underwater sail (12) where buoys (13) support the rope instead of helium balloons. Instead of controllable pitch, the lines (14) between rope and sail could be drawn in by a mechanism (15) which would minimize sail drag during rope recovery. Alternatively, the rope drum (5) and bottom components (gearbox, generator, etc.) could be moved toward the sail to reel in the rope. This would be cost-effective if the bottom components were mounted to a ship, barge, or other mobile device.

The top edge of a sail might have buoys (16) and the bottom edge might have weights (17) to keep the sail open and nearly vertically. In a device where the bottom components are fixed in location, the winch drum and generator could be enclosed in a subsea pod at seabed or riverbed. If the drum and generator were mounted to the deck of a mobile piece of equipment, such as a ship, then the ship would likely be temporarily fixed into position by mooring lines, anchors, dynamic positioning, or another means by which to keep the drum in a fixed location during rope pulling operations. In times of exceptionally severe storms or incoming hurricanes/typhoons the sail, wing, or other means by which to extract force could be quickly recovered and the ship could sail away. Barges placed in ocean currents could potentially deploy both wind and water versions of this invention with many wings/sails installed on each line. In this way, both wind and currents could be harnessed simultaneously. It may be desirable to install subsea video cameras, or standard video cameras enclosed in plexiglass, to monitor whether marine life ever swam near or into contact with a sail. This is contact with marine life is a possibility but the system is certainly more safe than arrays of marine turbines with dozens if not hundreds of slicing turbine blades.

A different and more specialized motor (18) may better suited to reel in slack rope than the energy producing generator (8). In this alternative embodiment the dedicated motor (18) would be used to reel in rope while a different dedicated generator (8) would produce electricity when the rope paying out. In ocean currents it might be advantageous to pay out many miles of rope and have the device generating power for extremely long periods of time. After each payout cycle the ship might then travel to the sail during late night hours (when the power consumption of a city was low) to recover slack cable. With multiple devices operating with staggered timing the total power output could be made to be fairly constant. Currents and rivers never stop, so this would be “baseline” energy where no other back-up power plants are required. This is a significant advantage over other wind, solar, and wave energy systems.

A computer, software, transmitter, and other associated equipment (11) could automatically control many if not all of the items without human involvement. The absence of human involvement considerably lowers an energy system's cost/kWh. A computer, software, transmitter, and other associated equipment, or other means by which to control systems, could also optimize a system's energy production by balancing the electrical load placed upon the generators. For example, if electrical load were too high the generator would spin under great torque but slow rpm which is not the optimum way to generate electricity. If the electrical load were too low then the generator could spin with high rpm but too low of torque (again not the ideal way to generate power). An optimum balance between torque and rpm should be maintained which could be achieved via electrical switches (15) and controlling electrical load or by other means. Since some of these items can be controlled mechanically versus by computer and software then I shall claim a means by which to either balance electrical load or otherwise control the payout rate of the device.

A levelwind (19) or other component for evenly layering the rope or ropes on the storage drums would be very useful especially when long rope lengths are used. It would ensure that rope storage was efficient and the size of the drum was minimized.

What is claimed is:

1. A device for transforming the energy of moving air or moving water into useable energy comprising a means by which to receive the force generated by moving air or moving water, a means by which to control the means by which to receive the force generated by moving air or moving water, one or more ropes, one or more rope storage drums, one or more generators, and a means by which to operate one or more components at least semi-automatically.

2. The device of claim 1 with a means by which to control electrical load or otherwise control the payout rate of the device for improved if not optimized energy production.

3. The device of claim 1 with a levelwind or other means by which to reel in and store rope fairly evenly on a drum.

4. The device of claim 1 whereby a gearbox or transmission is added which increases the rotational speed of a generator.

5. The device of claim 1 with one or more one-way clutches or other means by which to temporarily disengage one or more components during rope reeling.

6. The device of claim 1 whereby at least one generator is dedicated to producing electricity and there is a separate means to reel in rope.

7. The device of claim 1 with a means by which to support the weight of one or more ropes such as via balloons or buoys.

8. A device for transforming the energy of moving air or moving water into useable energy comprising a means by which to receive the force generated by moving air or moving water, a means by which to control the means by which to receive the force generated by moving air or moving water, one or more ropes, one or more rope storage drums, a levelwind or other means by which to reel in and store rope fairly evenly on a drum, one or more generators, and a means by which to operate one or more components at least semi-automatically.

9. The device of claim 8 with a means by which to control electrical load or otherwise control the payout rate of the device for improved if not optimized energy production.

10. The device of claim 8 whereby a gearbox or transmission is added which increases the rotational speed of a generator.

11. The device of claim 8 with one or more one-way clutches or other means by which to temporarily disengage one or more components during rope reeling.

12. The device of claim 8 whereby at least one generator is dedicated to producing electricity and there is a separate means to reel in rope.

13. The device of claim 8 with a means by which to support the weight of one or more ropes such as via balloons or buoys.

14. The device of claim 1 with buoys or floats attached near the top of the device.

15. The device of claim 8 with buoys or floats attached near the top of the device.

16. One or more helium balloons attached to a wind energy device rope, umbilical, tether, or other cable whereby one or more balloons are removed prior to a rope being reeled in and one or more balloons are attached after a rope has been paid out.
